(19) United States
(12) Patent Application Publication
(10) Pub. No.: US 2025/0206540 A1
(43) Pub. Date: Jun. 26, 2025

(54) CONVEYOR BELT SIDEWALL FASTENER

(71) Applicant: Habasit America, Inc., Suwanee, GA (US)

(72) Inventors: Andres ZAPATA, Suwanee, GA (US); Armin MEMOVIC, Suwanee, GA (US); Angel CANCEL, Suwanee, GA (US)

(21) Appl. No.: 18/845,407

(22) PCT Filed: Mar. 7, 2023
(86) PCT No.: PCT/US2023/063889

§ 371 Date: Sep. 9, 2024

Related U.S. Application Data
(60) Provisional application No. 63/317,221, filed on Mar. 7, 2022.

(51) Int. Cl. B65G 15/42

(52) U.S. Cl. CPC B65G 15/42; B65G 2812/02138

(57) ABSTRACT

A fastener (1) comprising a) a fastener member (2) and one or more tenons (41,42,43) arranged on the front face (21) and being spaced apart from each other in said elongation direction (3), and b) at a proximal end (22) of the fastener member (2) a protrusion (5) comprising one or more fastener hinge knuckles (61,62). The fastener can be used to simultaneously join the ends (81,82) of a conveyor belt (8), the ends being designed tor form with a lace pin an end joint in the form of a continuous hinge (12), and the ends (1101,1102) of a corrugated sidewall (110) that is attached to the conveying surface (83) of the conveyor belt (8).

### BACKGROUND

There are many goods conveyed on a conveyor belt that do not allow contamination to come into contact with the conveyed good. Examples therefor are foodstuffs. The sources of contamination may e.g. from environmental dirt, abraded particles from the belt surface and even debris from the conveyed goods themselves. In order to reduce contamination it is necessary to frequently clean the conveyor belt or to even replace it. Mounting of a conveyor belt normally comprises a final step wherein an open-ended conveyor belt is made endless by an end-joining method. Dismounting the conveyor belt normally comprises an initial step where the endless belt is opened to make it open-ended. If such mounting and dismounting must be done frequently then the normal end-joining methods such as the finger-end joining method which bond the belt ends by heat and pressure and perhaps also a hotmelt adhesive together are too tedious. A mechanical end-joining system is then used, the most comfortable for quick joining and re-opening being one in the form of a continuous hinge with hinge knuckles. An example for such mechanically end-joined conveyor belts are the Cleandrive® belts marketed by Habasit AG at the time of filing of the instant application.

On the other hand there were conveyor belts equipped with corrugated sidewalls protruding up from the conveying surface of the conveyor belt. The purpose of the sidewalls is to prevent the conveyed good from slipping from the conveying surface. These sidewalls are customarily made of a plastic (thermoplastic) and are thus welded or glued to the conveying surface of the conveyor belt. Since a conveyor belt in operation bends over idler and driving pulleys the sidewalls must have some stretchability in longitudinal direction in order to account for the longitudinal extension of the sidewalls when the conveyor belt bends over the pulley, which longitudinal extension becomes linearly more pronounced with increasing distance from the belt's conveying surface. A customary way to provide the sidewalls with such longitudinal stretchability is to shape them in a wavy form with alternating crests and troughs running perpendicular to the conveying surface. These perpendicular waves allow an accordion-like longitudinal stretching of the sidewalls. Such wavy-shaped sidewalls are called in the art “corrugated” sidewalls. On the internet there are many photographs showing the behaviour of such corrugated sidewalls while the conveyor belt is bent over a pulley. Corrugated sidewall conveyor belts as such have been known for quite some time. Reference is made by way of example to GB 1 567 074 A, which is presumably not the first publication describing them. The above mentioned Cleandrive® belts can optionally also be equipped with such corrugated sidewalls.

The problem with such corrugated sidewall conveyor belts is that upon end-joining thereof both the belt itself and the two sidewalls must be made endless. Similarly, dismounting an endless corrugated sidewall conveyor belt requires that the belt and the two sidewalls be opened simultaneously. There have been some prior art attempts to end-join open-ended corrugated sidewall conveyor belts.

WO 2018/071139 A2 discloses a sidewall bonder and a method for bonding sidewalls to thermoplastic belts at a splice joint. This bonder fuses the ends of the sidewall together using heating jaw assemblies. Welding the sidewall with such a portable press requires expensive equipment and specialized training, making it inconvenient for cleaning and preventative maintenance.

An “Installation, Maintenance and Repair Manual for Heavy Duty Corrugated Sidewall Belting” published by Apache Inc. discloses on pages 14-16 a splicing method for the sidewalls wherein the sidewall ends of a belt having a mechanical joint with a mechanical lace pin are simply spliced together using elevator bolts with lock nuts and flat face washers. The sidewall joining is offset with respect to the mechanical joint in longitudinal direction by a distance “X”.

A commercial corrugated sidewall end joining system is the “Thermodrive® Synchronized Sidewall Mechanical Fastener Kit” from Intralox intended for belts having a mechanical joint with a mechanical lace pin. This kit consists of a plates screws, and nuts to hold sidewalls together at the mechanical joint. This end joining kit does however not interact in any way with the mechanical joint, it simply joins the end portions of the sidewalls together. This system may corrode, in view of the metal plates, or pieces may come unfastened during operation, risking contamination of the conveyed product.

There is still the problem that there is no good existing way to non-permanently fasten sidewalls to each other on either side of the join for a belt with a mechanical lace.

### SUMMARY OF THE INVENTION

The invention provides a fastener comprising:
a) a fastener member comprising a front face being elongated in an elongation direction and one or more tenons arranged on the front face and being spaced apart from each other in said elongation direction, and
b) at a proximal end of the fastener member a protrusion comprising one or more fastener hinge knuckles; each comprising a fastener knuckle pin hole with a central axis, all central axes being aligned on one sole rotational axis; said rotational axis and said elongation direction intersecting each other at an angle of essentially 90°.

Preferred embodiments of the fastener are according to the dependent claims.

The invention also provides a conveyor belt with two ends and having one or two in particular corrugated sidewalls with respective ends, the belt ends and the ends of these sidewalls being fastened together by the inventive fastener, and processes for producing such conveyor belts.

### BRIEF DESCRIPTION OF THE FIGURES

FIG. 1 is a perspective view of an inventive conveyor belt end and conveyor belt sidewall end fastener;

FIG. 2 is a partial cut view of the fastener of FIG. 1, when used to fasten belt ends and belt sidewall ends together;

FIG. 3 is a side view of the fastener of FIG. 1;

FIG. 4 is a bottom view view of the fastener of FIG. 1, when used to fasten belt ends and belt sidewall ends together.

### DETAILED DESCRIPTION OF THE INVENTION

The inventive sidewall fastener is of approximately L-shape, particularly if the aforementioned angle α is approximately or exactly 90°, with the fastener member typically forming the one, longer leg of the L and the protrusion forming the second, shorter leg of the L. It is preferably single piece moulded and in this preferred embodiment it contrasts to the existing multi-piece system mentioned in the introduction that currently is used. This one piece design makes it such that the risk of a loose part entering conveyed material is virtually non-existent. It is also a tool-less install/removal once the holes are in place. There is no risk of metal flakes or corrosion as there is in the existing system.

The inventive fastener comprises a fastener member which may have any suited form such as a plate, cuboid or rod; preferred is the shape of a plate. In the latter case the edges may be rounded off. Essential is that the fastener member comprises an elongated front face upon which the two sidewall ends will lie after being fastened together by the tenons of the inventive fastener. The front face typically has a constant cross-sectional profile along a given length in a given direction and this length and direction are the “elongation” in “elongation direction”, respectively, of the front face. The front face may typically be either planar, or may have the shape of a trough with concave profile (if the front face is intended to receive two sidewall ends shaped as wave crests) or may have the shape of a crest with convex profile (if the front face is intended to receive two sidewall ends shaped as wave troughs). In these two latter cases the curvature of the cross-sectional profile of the front face in its elongation direction preferably approximately matches the curvature of the cross-sectional profile of the trough- or crest-shaped sidewall end that will lie directly on the front face. “Approximately” may preferably mean that the curvature of a concave cross-sectional profile of the front face is slightly lower than the curvature of a convex cross-sectional profile of a wave crest in question. For instance, if the curvature of the concave cross-sectional profile of the front face is circular with a given, constant radius r_{c} and the convex curvature of the cross-sectional profile of the wave crest in question is also cricular with a given, constant radius r_{w}, then typically 1.05r_{w}≥r_{c}≥1.0r_{w}. On the other hand “approximately” may preferably mean that the curvature of a convex cross-sectional profile of the front face is slightly higher than the curvature of a concave cross-sectional profile of a wave trough in question. For instance, if the curvature of the convex cross-sectional profile of the front face is circular with a given, constant radius r_{c} and the concave curvature of the cross-sectional profile of the wave trough in question is also cricular with a given, constant radius r_{w}, then typically 0.95r_{w}≤r_{c}≤1.0r_{w}.

The front face of the fastener member carries one or more tenons. The size and shape of these tenons is such that they can engage the holes in the sidewall ends, thus fastening the two ends of sidewalls, in particular corrugated sidewalls together.

A preferred mode of fastening the holes of the sidewall ends to the tenons is by snap-fit, also in view or producing the inventive fastener integrally in one piece (see below). For this preferred mode the tenons may typically have at their apex a circumferential ridge of slightly greater diameter than the diameter of the holes of the sidewalls which they are to engage. Since the material of the sidewalls normally is non-rigid, such as of a thermoplastic, the holes of the sidewall may expand slightly in diameter when being pressed onto the tenons, which allows the said circumferential ridge of slightly greater diameter to pass through the sidewall holes. Because the material of the tenons typically also non-rigid, such as of a thermoplastic, the circumferential ridge may also be compressed somewhat while passing trough the holes of the sidewalls. After fastening by snap-fit the said circumferential ridge act as a barrier against unwanted release of the sidewall ends from the tenons.

The number of tenons on the inventive fastener is preferably from 1 to 5, more preferably from 2 to 4 and most preferably 3. The number and position of the holes on each sidewall end must preferably be accordingly matched to the number and position of the tenons.

The “proximal” and “distal” ends of the fastener member are proximal and distal, respectively, to the protrusion carrying the one or more hinge knuckles.

The inventive fastener comprises a protrusion which may have any shape, as long as it can accommodate one or more hinge knuckles each having a cylindrical hole and the central axes of all these cylindrical holes coinciding with each other such as to form a rotational axis for the mechanical lace pin. The preferred shape for the protrusion is a rod or bar. The length of the protrusion in direction of the rotational axis is preferably equal to kW_{f}+(k−1)P_{f}, wherein k is the number of fastener hinge knuckles, W_{f} is the width of each fastener hinge knuckle and P_{f} is the pitch between adjacent fastener hinge knuckles. The protrusion may comprise at its attachment site to the proximal end of the fastener member a pedestal of somewhat greater diameter and/or greater cross-sectional area than the protrusion itself to enhance rigidity thereof. The pedestal may in particular have the shape of a conus that tapers from the attachment site to the proximal end up to a certain fraction of the length of the protrusion, after which fraction the protrusion may have an essentially constant diameter and/or cross-section. In this case the sidewall ends to be attached together may be provided with an appropriately shaped recess to fit into the pedestal.

The hinge knuckles of the inventive fastener are intended to engage the lace pin that will mechanically join the ends of the conveyor belt which are shaped and joined in the form of a continuous hinge as described in the introduction. The essential functional feature of each such hinge knuckle is that it contains a cylindrical knuckle pin hole of suited internal diameter such as to match the given outer diameter of the lace pin that will join the ends of the conveyor belt. The central axis of each of the knuckle pin holes therefore defines, and coincides with, the rotational axis of the lace pin. When the inventive fastener is oriented such that the elongation direction of the front face is vertical and the proximal and distal ends of the fastener member are on the bottom and on the top, respectively, then the hinge knuckle(s) typically extend, or protrude, below the proximal end of the fastener member and away from the tenons in order for the central axes of their cylindrical knuckle pin holes to pass below the fastener member and thus to allow free, unobstructed passage of the lace pin.

The number of hinge knuckles on the inventive fastener is preferably from 1 to 4, more preferably from 2 to 3 and most preferably 2.

The fastener hinge knuckles are preferably dimensioned and shaped such that they are compatible with the hinge knuckles of the ends of the conveyor belt. That is, each hinge knuckle on the inventive fastener is preferably dimensioned and shaped such that it can engage a recess between neighbouring hinge knuckles at one end of the conveyor belt, with the corresponding hinge knuckle on the other belt end that would normally engage the said recess being omitted. In this case the pitch P_{f} between neighbouring fastener hinge knuckles is preferably essentially identical to the pitch Pb between neighbouring belt hinge knuckles on the ends of the belt. As “spacing” between neighbouring hinge knuckles is understood the distance between the front face of the one neighbouring hinge knuckle and the front face of the other neighbouring hinge knuckle, in direction of the central axes of the cylindrical knuckle pin holes of the neighbouring hinge knuckles, the two front faces being preferably planar and perpendicular to the central axes of the cylindrical knuckle pin holes, and the two front faces facing each other.

The direction in which the front face of the fastener member is elongated and the rotational axis defined by the central axes of all cylindrical knuckle pin holes of all knuckle pins overcross each other, when seen in a direction perpendicular to both the rotational axis and the elongation direction, at an angle α of essentially 90°. The term “essentially” may mean an angle of 70° to 110°, preferably of 80° to 100° and most preferably exactly 90°. An angle of exactly 90° is required when the troughs and crests of the waves of the corrugated sidewalls run exactly perpendicular to the conveying surface of the conveyor belt, and thus to the lace pin joining the two belt ends together. A given angle α of less than 90° or more than 90° may be necessary when the troughs and crests of the waves of the corrugated sidewalls run in an inclination of the same angle α of less than 90° or more than 90°, respectively, with respect to the lace pin joining the two belt ends together.

The inventive faster may be adapted to different spatial situations of conveyor belt surface and sidewalls attached thereto not only by the number of fastener hinge knuckles and their width W_{f} and the pitch P_{f} between them but also by appropriately choosing the offset L in direction of the rotational axis between, on the one hand, the intersection of the elongation direction of the front face and the rotational axis and, on the other hand, the position of the fastener hinge knuckle closest to the fastening member. If the fastener is to fasten two corrugated sidewall ends in the form of troughs together (troughs are understood as more remote to the belt's lateral edge than the crests) then L may be significantly positive, that is, the fastener hinge knuckle closest to the fastening member is offset in rotational axis direction with respect to said intersection in the same direction as the pointing direction of the tenons. Alternatively, f the fastener is to fasten two corrugated sidewall ends in the form of crests together (crests are understood as closer to the belt's lateral edge than the troughs) then L may be significantly negative, that is, the fastener hinge knuckle closest to the fastening member is offset in rotational axis direction with respect to said intersection in the opposite direction as the direction in which the tenons point. Still furthermore, if the inventive fastener is to fasten two flattened out ends of corrugated sidewalls, the L may be essentially zero.

The inventive fastener is preferably made integrally in one piece, such as by injection-moulding, more preferably from a thermoplastic having a Shore A hardness at 25° in the range of 80 to 100, more preferably of 90 to 100. Suited thermoplastics are e.g. polyesters, polyamides, thermoplastic polyurethanes or polycarbonates. The preferred thermoplastic is a thermoplastic polyurethane with a Shore A hardness at 25° C. in the range of 90 to 100, in particular of Shore A hardness of 95. The thermoplastic may optionally be blended beforehand with customary pigments or dyes in customary amounts, to obtain the inventive fastener in a coloured form. Likewise the thermoplastic may optionally be blended beforehand with particulate metal, such as powdered aluminium or powdered ferromagnetic metals. This allows to detect any debris or fragments that might be loosened or broken off the inventive fastener and that would be carried on the conveyor belt by means of a metal or X-ray detector. If X-ray detection is used then also (in particular inorganic) heavy metal compounds may be used, such as barium sulfate. Many inorganic pigments for colouring are metal compounds themselves and may simultaneously allow colouring and X-ray detection of debris and fragments, such as (deactivated) titanium dioxide, iron oxides and cadmium sulfide. Early detection and removal of any such debris or fragments is particularly important in the case of a conveyor containing the inventive fastener being employed in the field of food processing.

The inventive fastener can be used in a process of joining the ends of an open-ended sidewall-bearing conveyor belt with belt ends comprising hinge knuckles configured to be mechanically joined by a lace pin to form an end joint in the form of a continuous hinge. Both the sidewall-bearing conveyor belt fastened with the inventive fastener and the associated process form part of the invention.

The inventive process concerns the joining of a first and a second conveyor belt end, the conveyor belt having a conveying surface to which a sidewall is attached, the sidewall having a first sidewall end that substantially coincides with the first belt end and a second sidewall end that substantially coincides with the second belt end, and the first and second belt ends each comprising alternating belt hinge knuckles and belt recesses, each belt hinge knuckle having a width W_{b} and comprising a cylindrical belt knuckle pin hole, and the alternating belt hinge knuckles and belt recesses being configured such that each belt hinge knuckle on the first belt end can engage a belt recess on the second belt end and each belt hinge knuckle on the second belt end can engage a belt recess on the first belt end, and the cylindrical belt knuckle pin holes of all belt hinge knuckles in such engaged state are aligned such that their central axes are aligned on one sole rotational axis and are capable of accommodating a lace pin and to form by such lace pin accommodation a belt end joint in the form of a continuous hinge, comprising the steps of: a) providing an inventive fastener; b) omitting or removing from the first belt end near the first sidewall end and/or from the second belt end near the second sidewall end a total number of belt hinge knuckles being equal to the number of fastener hinge knuckles, to produce by each omitted or removed belt hinge knuckle an omission recess with a position such as to enable the engaging, instead of the omitted or removed belt hinge knuckle, of one of the fastener hinge knuckles; c) engaging all remaining hinge knuckles into their respective recesses and inserting the fastener hinge knuckles into the respective omission recesses produced in step b) such that the central axes of all cylindrical belt knuckle pin holes and the central axes of all cylindrical fastener knuckle pin holes are aligned on one sole rotational axis; d) passing a lace pin through all the aligned cylindrical belt knuckle pin holes and all the aligned cylindrical fastener knuckle pin holes to form a continuous hinge also containing the fastener hinge knuckles; e) providing each of the first and second sidewall ends with a number of holes at a position and spacing such as that each hole on the first sidewall end matches a corresponding hole on the second sidewall end, and vice-versa, to form matched hole pairs, each hole pair in turn matching a corresponding tenon on the inventive fastener, and vice-versa; and f) fastening both holes of each hole pair to the respective tenon of the inventive fastener to also form an end-joined sidewall. The inventive process may be applied, simultaneously or sequentially, to a process of end-joining of a conveyor belt also having a second sidewall attached to its conveying surface. The second sidewall will then comprise a third and a fourth sidewall end, wherein the third sidewall end substantially coincides with the first belt end and the fourth sidewall end substantially coincides with the second belt end, and that process also joins the third and fourth sidewall ends of the second sidewall. The steps for this simultaneous or sequential process are as outlined above for the inventive process itself, with the provisos that any references to a “sidewall” are replaced by a reference to a “second sidewall”, any references to a “first sidewall end” are replaced by a reference to a “third sidewall end”, any references to a “second sidewall end” are replaced by a reference to a “fourth sidewall end”, and any references to an “inventive fastener” are replaced by a reference to an “inventive second fastener”. This preferred process in which the ends of both a first sidewall and of a second sidewall are joined thus furthermore comprises: in above step a) to also provide a second inventive fastener; in step b) to also omit or remove from the first belt end near the third sidewall end and/or from the second belt end near the fourth sidewall end a total number of belt hinge knuckles being equal to the number of fastener hinge knuckles of the second inventive fastener, to produce by each omitted or removed belt hinge knuckle a further omission recess with a position such as to enable the engaging, instead of the omitted or removed belt hinge knuckle, one of the fastener hinge knuckles of the second fastener; in step c) to also insert the fastener hinge knuckles of the second fastener into the respective further omission recesses also produced in step b), such that the central axes of all cylindrical knuckle pin holes are aligned on one sole rotational axis; in step e) to also provide each of the third and fourth sidewall ends with a number of holes at a position such as that each hole on the third sidewall end matches a corresponding hole on the fourth sidewall end and vice-versa, to form matched second hole pairs, each second hole pair in turn matching a corresponding tenon on the second fastener, and vice-versa; and in step f) to also fasten both holes of each second hole pair to the respective tenon of the second fastener to also form thereby an end-joined second sidewall.

An inventive conveyor belt is obtainable by either of the foregoing inventive processes.

An inventive conveyor belt comprises an inventive fastener, first and second belt ends each comprising alternating belt hinge knuckles and belt recesses, and a sidewall with a first sidewall end substantially coinciding with the first belt end and a second sidewall end substantially coinciding with the second belt end, each belt hinge knuckle comprising a cylindrical knuckle pin hole, wherein each belt hinge knuckle on the first belt end engages a belt recess on the second belt end and each belt hinge knuckle on the second belt end engages a belt recess on the first belt end, wherein from the first belt end near the first sidewall end and/or from the second belt end near the second sidewall end a total number of belt hinge knuckles being equal to the number of fastener hinge knuckles is omitted or removed, wherein by each omitted or removed belt hinge knuckle an omission recess is formed which engages, instead of the omitted or removed belt hinge knuckle, one of the fastener hinge knuckles, and the central axes of all cylindrical knuckle pin holes are aligned on one sole rotational axis, and a lace pin passes through all the aligned cylindrical knuckle pin holes to form a continuous hinge also containing the fastener hinge knuckles; each of the first and second sidewall ends comprise a number of holes at a position and spacing such as that each hole on the first sidewall end matches a corresponding hole on the second sidewall end, and vice-versa, to form matched hole pairs, each hole pair in turn matching a corresponding tenon on the inventive fastener, and vice-versa; and both holes of each hole pair being fastened to the respective tenon of the inventive fastener, to thereby also form an end-joined sidewall.

The term “sidewall end substantially coinciding with a belt end” may mean for the purposes of the invention that the (perpendicular) ending edge of the sidewall end in question is spaced apart from the belt end in question (that is, from the ending edge of a recess of that belt end being intended to engage a belt hinge knuckle on the other belt end) and in longitudinal belt direction by a distance X which is 1.0 to 3.0 times the length of a belt hinge knuckle in longitudinal belt direction.

A preferred inventive conveyor belt furthermore also comprises a second inventive fastener, and a second sidewall with a third sidewall end substantially coinciding with the first belt end and a fourth sidewall end substantially coinciding with the second belt end, wherein from the first belt end near the third sidewall end and/or from the second belt end near the fourth sidewall end also a total number of belt hinge knuckles being equal to the number of fastener hinge knuckles on the second fastener is omitted or removed, wherein by each omitted or removed belt hinge knuckle also a further omission recess is formed which engages, instead of the omitted or removed belt hinge knuckle, also one of the fastener hinge knuckles of the second fastener, and the central axes of all cylindrical knuckle pin holes are aligned on one sole rotational axis, and a lace pin passes through all the aligned cylindrical knuckle pin holes to form a continuous hinge also containing the fastener hinge knuckles of the second fastener; each of the third and fourth sidewall ends comprise a number of holes at a position and spacing such as that each hole on the third sidewall end matches a corresponding hole on the fourth sidewall end, and vice-versa, to form matched further hole pairs, each further hole pair in turn matching a corresponding tenon on the second fastener, and vice-versa; and both holes of each further hole pair being fastened to the respective tenon of the second fastener, to thereby also form an end-joined second sidewall.

For both the above inventive processes and inventive conveyor belts any reference to a “sidewall” preferably refers to a “corrugated sidewall” as outlined in the introduction.

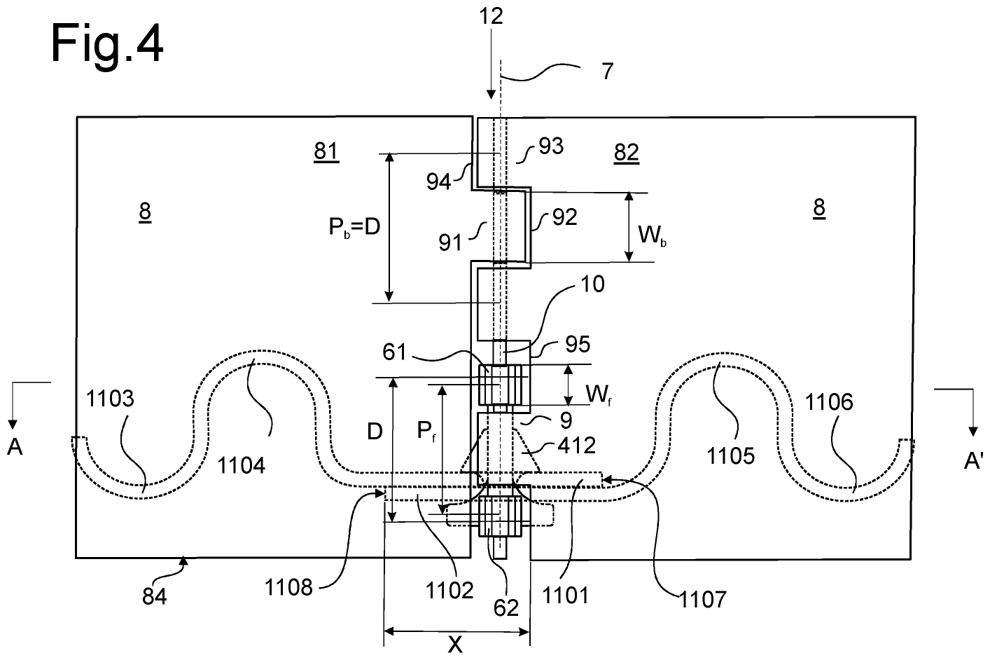

For the inventive belt and process the following features are preferred:
1) each hinge knuckle on the inventive fastener is dimensioned and shaped such that it can engage a recess between neighbouring hinge knuckles at one end of the conveyor belt. The width W_{f} of the fastener hinge knuckle(s) in direction of the central axis of the cylindrical knuckle pin hole contained therein is therefore at the most equal to the width W_{b} of the hinge knuckles and associated recesses between neighbouring hinge knuckles on one of the belt ends in the same direction, W_{f}≤W_{b}. Preferably W_{f} is in the range of 50% to 95% of W_{b} to allow for a certain clearance between the fastener hinge knuckle and the said neighbouring two hinge knuckles on a belt end. The widths W_{f} and W_{b} are measured for the purposes of the invention from the one front face of the hinge knuckle in question to the opposite front face of the same hinge knuckle in question, in direction of the rotational axis 7 of the lace pin 10 (see also FIG. 4).
2) For each pair of n-th and (n+1)-th consecutive fastener hinge knuckles, separated from each other in the direction of the rotational axis by the pitch P_{f}, there must be a corresponding pair of omitted belt hinge knuckles on the belt end(s), wherein the omitted belt hinge knuckles may be on one and the same end, or one omitted belt hinge knuckle is on the one belt end and the other omitted belt hinge knuckle is on the other belt end. The omitted hinge knuckles are separated from each other by a distance D which preferably is essentially identical to an integer multiple of the pitch P_{f}.

D≈mP_{f}, m=1, 2, 3 . . .

Each said distance D is also an exact integer multiple of the pitch P_{b}/2 between adjacent belt hinge knuckles (between a belt hinge knuckle on one belt end and the next belt hinge knuckle on the other belt end), wherein P_{b} is the pitch between neighbouring belt hinge knuckles on one and the same belt end:

$$D = I \frac{{P}_{b}}{2} , I = 2 , 3 , 4$$

The I cannot be 1 because there must be at least one belt hinge knuckle between two neighbouring fastener hinge knuckles. This definition of D again means that the omitted n− and (n+1) hinge knuckles separated by that D need not be on the same belt end (see above). For omitted belt hinge knuckles separated by that D and being on the same belt end the I is an even integer, thus 2, 4, 6, . . . D is more preferably in the range of 90% to 110%, more preferably in the range of 95% to 105% of nP_{f}. D must become closer to nP_{f} with increasing n and/or with increasing number of fastener hinge knuckles. The highest possible deviation of D from nP_{f}, and thus the highest applicability of the inventive fastener to belt ends with varying pitches P_{b}, is with n=1 and a number of fastener hinge knuckles equal to 2; in this case there is D=2P_{b}/2=P_{b} (see FIG. 4). This is a most preferred embodiment for the inventive fastener, the inventive conveyor belt containing the inventive fastener and the inventive process for joining the ends of a conveyor belt with sidewalls using the inventive fastener. The pitches P_{f} and P_{b} are measured for the purposes of the invention from the centre of the one hinge knuckle in question to the centre of the neighbouring hinge knuckle in question, in direction of the rotational axis of the lace pin (see also FIG. 4). Similarly the distance D by which two omitted hinge knuckles is separated is measured between the centre of one omitted hinge knuckle to the centre of the next omitted hinge knuckle, in direction of the rotational axis of the lace pin (see also FIG. 4).
3) The two belt ends lack a number of belt hinge knuckles equal to the number of the fastener hinge knuckles. This is because for each fastener hinge knuckle on one belt hinge knuckle on a belt end needs to be omitted; the former engages the lace pin instead of the omitted later. As already stated the omitted belt hinge knuckles may be omitted on one sole belt end or be omitted on both belt ends; essential is only that the omitted hinge knuckles in total (thus as the sum of the number of omitted belt hinge knuckles on the one belt end plus the number of omitted belt hinge knuckles on the other belt end) is equal to the number of the fastener hinge knuckles. For each pair of sidewall ends to be joined there is one inventive fastener needed; thus if there are two pairs of sidewall ends to be joined to form two endless sidewalls (the most common case) the total number of hinge knuckles to be omitted from the two belt ends doubles. The belt hinge knuckles to be omitted are conveniently omitted from the belt end(s) in proximity to the sidewall(s) such as to match the spatial arrangement of the inventive fastener with its hinge knuckles and its tenons.
4) The sidewalls are preferably not attached to the conveying surface near the belt ends to be joined, to allow for some bendability of the sidewall ends with respect to the conveyor belt during fastening thereof with the tenons of the inventive fastener. The longitudinal length of the final portion of a sidewall extending towards its end and that is not attached to the conveying surface may be considered as both the longitudinal length of the sidewall end and the longitudinal length of the belt end.

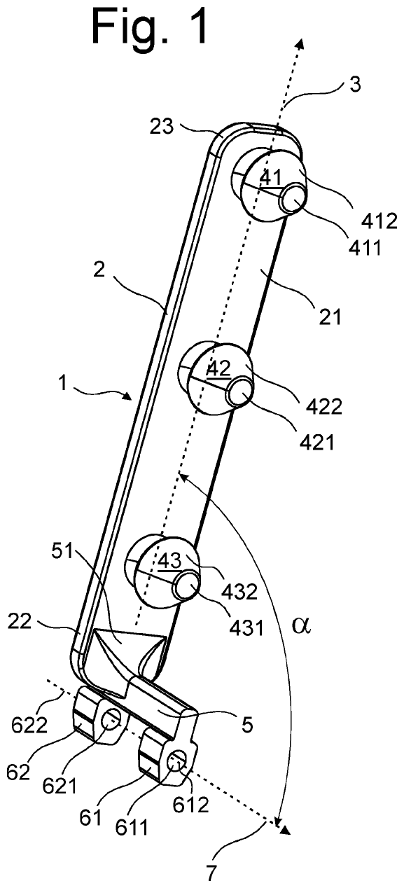

FIG. 1 shows an isolated inventive fastener 1. It comprises a fastener member 2 having a planar front face 21 elongated in an elongation direction 3. It comprises 3 tenons 41,42,43. Each of the tenons 41,42,43, has at its apex 411,421,431, respectively, a circumferential ridge 412,422,432, respectively, intended to enable snap-fit action of the tenons 41,42,43 with respective hole pairs at the ends of the conveyor belt sidewalls. The fastener 1 comprises at a proximal end 22 of the fastener member 2 a protrusion 5 comprising 2 hinge knuckles 61,62, each of these comprising a cylindrical knuckle pin hole 611,621, respectively. Each of these cylindrical knuckle pin holes 611,621 has a respective central axis 612,622, which are aligned to form one sole rotational axis 7 for the lace pin. The protrusion 5 comprises a pedestal 51 of greater diameter and/or cross-sectional area than the protrusion 5 itself, that pedestal 51 connecting the protrusion 5 to the proximal end 22 of the front face 21. The elongation direction 3 and the rotational axis 7 overcross each other at an angle α which is essentially or exactly 90°. The fastener of this embodiment is L-shaped; this fastener is thus intended for fastening conveyor belt sidewall ends which are essentially or exactly perpendicular to the conveying surface of the conveyor belt. The angle α may however deviate somewhat from 90° in order to match sidewalls which are inclined by the same angle with respect to the conveying surface of the conveyor belt. This inventive fastener is typically made integrally in one piece, such as by injection moulding, from a TPU with Shore A hardness 95. It may have the colour of the TPU itself or it may be coloured with pigments or dyes in suited amount and type to match the colour of the sidewall ends and/or the conveyor belt ends.

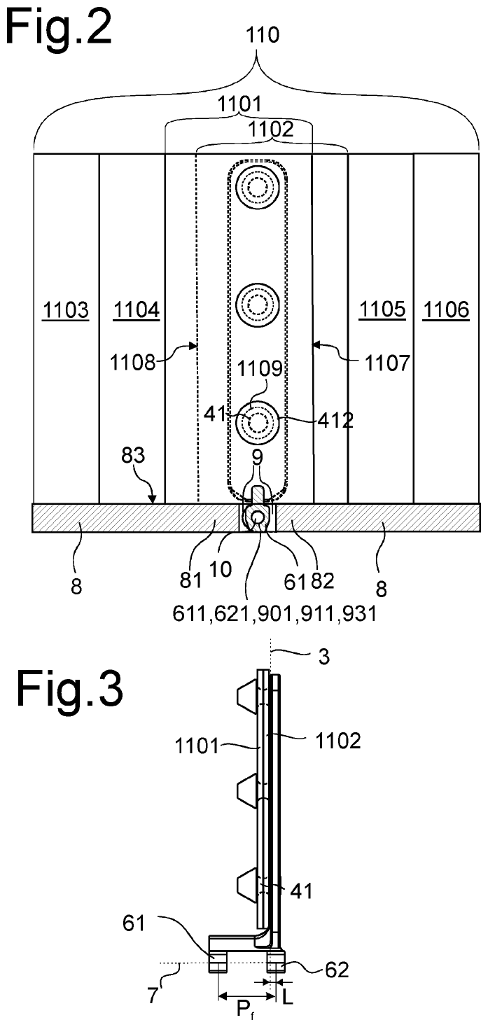

FIG. 2 shows the inventive fastener of FIG. 1 as partial cut view in mounted situation, when used for fastening the first and second ends 81,82 of a conveyor belt 8 and the first and second sidewall ends 1101,1102 of a first conveyor belt sidewall 110 together (the figure could also relate to fastening the first and second ends 81,82 of the conveyor belt 8 and the third and fourth sidewall ends of a second sidewall). FIG. 2 is thus also an illustration of the sidewall-bearing endless conveyor belt of the invention. The partial cut view is cut through the fastener hinge knuckle 61 (as the numeral of the corresponding hinge knuckle in FIG. 1), in direction A,A′ shown in FIG. 4. Any parts drawn with dashed lines are hidden or eclipsed by other parts drawn with solid lines. The fastener hinge knuckle 61 has a lace pin 10 inserted into its cylindrical knuckle pin hole 611. One belt hinge knuckle 9 attached to and extending from the right, second end 82 of the conveyor belt is shown; the lace pin 10 also passes through a (not shown) knuckle pin hole of that belt hinge knuckle 9. The belt hinge knuckle 9 is arranged in this view behind the first fastener hinge knuckle 61 and would be on top of the second fastener hinge knuckle (not shown in FIG. 2 as it is eclipsed by the first fastener hinge knuckle 61). There would be further belt hinge knuckles attached to and extending from the left (first) and right (second) belt ends 81,82 of the belt 8. From the first fastener hinge knuckle 61 there is shown its cylindrical knuckle pin hole 611 and, exactly eclipsed thereby, the cylindrical knuckle pin holes 901,911,931 of the belt hinge knuckles 9,91,93 appearing in FIG. 4. All cylindrical knuckle pin holes 611,901,911,931 are engaged by the lace pin 10 to form the eventual continuous hinge 12 shown in FIG. 4. The corrugated first sidewall 110 is composed of an alternating sequence of troughs (only two shown and denoted with numerals 1103, 1106) and crests (only two shown and denoted with numerals 1104, 1105). The first sidewall end 1101 extends from the last left sidewall trough 1104 to a right ending edge 1107; the second sidewall end 1102 extends from the last right sidewall trough 1105 to a left ending edge 1108 drawn as a dashed line because it is hidden by the first sidewall end 1101; in the fastened state the second sidewall end 1102 to which the second ending edge 1108 belongs lies behind the first sidewall end 1101. Both sidewall ends 1101,1102 have pairs of matching fastening holes (one such pair is designated with numeral 1109) which pairs are each fastened by snap-fit to one respective tenon of the fastener (the tenon in question is designated with numeral 41 as the corresponding tenon in FIG. 1). The tenons have a circumferential ridge designated with numeral 412 (as the corresponding circumferential ridge in FIG. 1) intended to enable the snap-fit with the respective hole pair at the sidewall ends.

FIG. 3 shows one way on how the inventive fastener can be adapted to different transversal positions (transversal with respect to the travel direction of the conveyor belt) of the sidewalls. This is necessary because, as stated, the sidewalls are normally corrugated and the inventive fastener may have to fasten together two crests of the sidewall ends, two troughs of the sidewall ends, or, as shown in FIG. 4, two flattened out sidewall ends. Each of these situations has different spatial requirements. In order to accommodate for these different situations the inventive fastener may be designed such as that the fastener hinge knuckle 62 most proximal to the front face 21 offset by a freely chose distance L from the intersection point between elongation direction 3 of the front face 21 and the rotational axis 7, in direction of the rotational axis 7. If the inventive fastener is to fasten together two flattened out sidewall ends 1101,1102, as shown both in FIG. 3 and in FIG. 4, then the said most proximal fastener hinge knuckle 62 may be essentially directly below the front face 21, so that the distance L is close or even equal to zero, as shown in FIG. 3. If the inventive fastener is to fasten together two troughs of the sidewall ends (the troughs 1103, 1106 would in the notation and view of FIG. 4 be closer to the lateral edge 84 of the belt 8) then L may be significantly positive (the said most proximal fastener hinge knuckle 62 is offset from the intersection of elongation direction 3 and rotational axis 7 in the direction in which the tenons of the fastener point). If the inventive fastener is to fasten together two crests of the sidewall ends (the crests 1104, 1105 would in the notation and view of FIG. 4 be more remote from the lateral edge 84 of the belt 8) then L may be significantly negative (the said most proximal fastener hinge knuckle 62 is offset from the intersection of elongation direction 3 and rotational axis 7 in a direction opposite to the direction in which the tenons of the fastener point). Once the distance L of the most proximal fastener hinge knuckle 62 from the intersection of the elongation direction 3 and the rotational axis 7 is given, the other fastener hinge knuckles, such as with numeral 61, may subsequently be spaced therefrom by the pitch Pr. In any cases of such non-zero distance L the above indicated formula for the length of the protrusion in direction of the rotational axis may become kW_{f}+(k−1)P_{f}+L, wherein all symbols are as defined above.

FIG. 4 shows the same situation as FIG. 2, but as a bottom view. Reference symbols that are identical in FIGS. 2 and 3 denote same parts; explanations given for a part with given reference symbol in FIG. 2 also apply to the same part in FIG. 3. This figure again shows schematically the corrugated sidewall comprising troughs 1103, 1106 and crests 1104, 1105, it is typically attached to the conveying surface near one of the lateral edges 84 of the belt 8. FIG. 4 shows specifically the interaction of the two fastener hinge knuckles 61,62 and of the hinge knuckles on the belt ends 81,82 with the lace pin 10. The fastener hinge knuckle 61 engages an omission recess 95 that was formed by omitting or removing a hinge knuckle from the first belt end 81; the fastener hinge knuckle 62 engages an omission recess that was formed by omitting or removing another hinge knuckle from the first belt end 81. The bulk of the continuous hinge that joins the first and second belt ends 81,82 together is formed by alternating hinge knuckles 91,93 that engage corresponding recesses 92,94 and by the lace pin 10 that runs through all hinge knuckles including the fastener hinge knuckles. FIG. 4 also illustrates the foregoing definitions of the pitches P_{f} and P_{b} and of the widths W_{f} and W_{b}. In this embodiment the width W_{f} of the fastener hinge knuckles 61,62 is only about 60% of the width W_{b} of the hinge knuckles on the belt ends. This allows for some clearance and movability of the inventive fastener in direction of the rotational axis 7. This further facilitates, together with the first and second sidewall ends 1101, 1102 not being attached to the first and second belt ends 81,82, the fastening of the hole pairs 1109 to the respective tenons 41 of the inventive fastener. The figure also illustrates the distance X which is intended to preferably define an end of the sidewall (there the left ending edge 1108) as “substantially coinciding” with a belt end (there the second belt end 82) of the conveyor belt as discussed in the general description.

1. A fastener (1) comprising:
a) a fastener member (2) comprising a front face (21) being elongated in an elongation direction (3) and one or more tenons (41,42,43) arranged on the front face (21) and being spaced apart from each other in said elongation direction (3), and
b) at a proximal end (22) of the fastener member (2) a protrusion (5) comprising one or more fastener hinge knuckles (61,62); each comprising a cylindrical fastener knuckle pin hole (611,621) with a central axis (612,622), all central axes (612,622) being aligned on one sole rotational axis (7);
said rotational axis (7) and said elongation direction (3) intersecting each other at an angle of essentially 90°.

2. The fastener (1) as claimed in claim 1, wherein the intersecting angle α is exactly 90°.

3. The fastener (1) as claimed in claim 1 or 2, comprising 2 to 4 tenons (41,42,43), preferably 3 tenons.

4. The fastener (1) as claimed in any one of the preceding claims, comprising 2 or more fastener hinge knuckles (61,62), preferably 2 fastener hinge knuckles.

5. The fastener (1) as claimed in any one of the preceding claims, wherein each fastener hinge knuckle (61,62) is of a width W_{f} in direction of said rotational axis (7) and neighbouring fastener hinge knuckles (61,62) are separated from each other in direction of said rotational axis (7) by a pitch P_{f}.

6. The fastener (1) as claimed in any one of the preceding claims, which is integrally made in one piece.

7. The fastener as claimed in any one of the preceding claims, which is made from a thermoplastic with a Shore A hardness of 80 to 100 at 25° C.

8. The fastener as claimed in claim 7, wherein the thermoplastic comprises a pigment or dye.

9. The fastener as claimed in claim 7 or 8, wherein the thermoplastic comprises a particulate, in particular powdered, metal.

10. The fastener as claimed in any one of claims 7 to 9 wherein the thermoplastic is a thermoplastic polyurethane.

11. A process of joining of a first (81) and a second (82) belt end of a conveyor (8), the conveyor belt (8) having a conveying surface (83) to which a sidewall (110) is attached, the sidewall (110) having a first sidewall end (1101) that substantially coincides with the first belt end (81) and a second sidewall end (1102) that substantially coincides with the second belt end (82), and the first and second belt ends (81,82) comprising alternating belt hinge knuckles (9,91,93) and belt recesses (92,94), each belt hinge knuckle (9,91,93) comprising a cylindrical belt knuckle pin hole (901,911,931), and the alternating belt hinge knuckles being configured such that each belt hinge knuckle (91) on the first belt end (81) can engage a belt recess (92) on the second belt end (82) and each belt hinge knuckle (93) on the second belt end (82) can engage a belt recess (94) on the first belt end (81), and the cylindrical belt knuckle pin holes (901,911,931) of all belt hinge knuckles (9,91,93) in such engaged state are aligned such that their central axes are aligned on one sole rotational axis (7) and are capable of accommodating a lace pin (10) and to form by such lace pin accommodation a belt end joint in the form of a continuous hinge (12), comprising the steps of:
a) providing a fastener (1) as claimed in any one of the preceding claims;
b) omitting or removing from the first belt end (81) near the first sidewall end (1101) and/or from the second belt end (82) near the second sidewall end (1102) a total number of belt hinge knuckles being equal to the number of fastener hinge knuckles (61,62), to produce by each omitted or removed belt hinge knuckle an omission recess (95) with a position such as to enable the engaging, instead of the omitted or removed belt hinge knuckle, one of the fastener hinge knuckles (61,62);
c) engaging all remaining belt hinge knuckles (91,93) into their respective belt recesses (92,94) and inserting the fastener hinge knuckles (61,62) into the respective omission recesses (95) produced in step b), such that the central axes (612,622) of all cylindrical fastener knuckle pin holes (611,621) and the central axes of all cylindrical belt knuckle pin holes (901,911,931) are aligned on one sole rotational axis (7);
d) passing a lace pin (10) through all the aligned cylindrical knuckle pin holes (611,621,901,911,931) to form a continuous hinge (12) also containing the fastener hinge knuckles (61,62);
e) providing each of the first (1101) and second (1102) sidewall ends with a number of holes at a position such as that each hole on the first sidewall end (1101) matches a corresponding hole on the second sidewall end (1102) and vice-versa, to form matched hole pairs (1109), each hole pair (1109) in turn matching a corresponding tenon (41) on the inventive fastener (1), and vice-versa; and
f) fastening both holes of each hole pair (1109) to the respective tenon (41) of the fastener (1) to also form an end-joined first sidewall (110), wherein step e) may also be carried out before steps d) and f).

12. The process as claimed in claim 11, wherein the conveying surface (83) has a second sidewall attached thereto, the second sidewall having a third sidewall end that substantially coincides with the first belt end (81) and a fourth sidewall end that substantially coincides with the second belt end (82), and furthermore comprising:
in step a) also providing a second fastener according to anyone of the preceding claims;
in step b) also omitting or removing from the first belt end (81) near the third sidewall end and/or from the second belt end (82) near the fourth sidewall end a total number of belt hinge knuckles being equal to the number of fastener hinge knuckles of the second fastener, to produce by each omitted or removed belt hinge knuckle a further omission recess with a position such as to enable the engaging, instead of the omitted or removed belt hinge knuckle, one of the fastener hinge knuckles of the second fastener;
in step c) also inserting the fastener hinge knuckles of the second fastener into the respective further omission recesses produced in step b), such that the central axes of all cylindrical knuckle pin holes are aligned on one sole rotational axis (7);
in step e) also providing each of the third and fourth sidewall ends with a number of holes at a position such as that each hole on the third sidewall end matches a corresponding hole on the fourth sidewall end and vice-versa, to form matched second hole pairs, each second hole pair in turn matching a corresponding tenon on the second fastener, and vice-versa; and
in step f) also fastening both holes of each second hole pair to the respective tenon of the second fastener to also form an end-joined second sidewall.

13. A conveyor belt obtained or obtainable by the process as claimed in claim 11 or claim 12.

14. A conveyor belt comprising a fastener (1) as claimed in anyone of claims 1 to 10, first and second belt ends (81,82) each comprising alternating belt hinge knuckles (9,91,93) and belt recesses (92,94), and a sidewall (101) with a first sidewall end (1101) substantially coinciding with the first belt end (81) and a second sidewall end (1102) substantially coinciding with the second belt end (82), each belt hinge knuckle (9,91,93) comprising a cylindrical belt knuckle pin hole (901,911,931), wherein each belt hinge knuckle (91) on the first belt end (81) engages a belt recess (92) on the second belt end (82) and each belt hinge knuckle (93) on the second belt end (82) engages a belt recess (94) on the first belt end (81), wherein from the first belt end (81) near the first sidewall end (1101) and/or from the second belt end (82) near the second sidewall end (1102) a total number of belt hinge knuckles being equal to the number of fastener hinge knuckles (61,62) is omitted or removed, wherein by each omitted or removed belt hinge knuckle an omission recess (95) is formed which engages, instead of the omitted or removed belt hinge knuckle, one of the fastener hinge knuckles (61,62), and the central axes (612,622) of all fastener cylindrical knuckle pin holes (611,621) and the central axes of all cylindrical belt knuckle pin holes (901,911,931) are aligned on one sole rotational axis (7), and a lace pin (10) passes through all the aligned cylindrical knuckle pin holes (611,621,901,911,931) to form a continuous hinge (12) also containing the fastener hinge knuckles (61,62); each of the first and second sidewall ends (1101,1102) comprise a number of holes at a position and spacing such as that each hole on the first sidewall end matches a corresponding hole on the second sidewall end, and vice-versa, to form matched hole pairs (1109), each hole pair (1109) in turn matching a corresponding tenon (41) on the inventive fastener (1), and vice-versa; and both holes of each hole pair (1109) being fastened to the respective tenon (41) of the inventive fastener (1), to thereby also form an end-joined sidewall (110).

15. The conveyor belt as claimed in claim 14, comprising a second fastener according to any one of claims 1 to 10, and a second sidewall with a third sidewall end substantially coinciding with the first belt end (81) and a fourth sidewall end substantially coinciding with the second belt end (82), wherein from the first belt end (81) near the third sidewall end and/or from the second belt end (82) near the fourth sidewall end also a total number of belt hinge knuckles being equal to the number of fastener hinge knuckles on the second fastener is omitted or removed, wherein by each omitted or removed belt hinge knuckle also a further omission recess is formed which engages, instead of the omitted or removed belt hinge knuckle, also one of the fastener hinge knuckles of the second fastener, and the central axes of all cylindrical knuckle pin holes are aligned on one sole rotational axis, and a lace pin passes through all the aligned cylindrical knuckle pin holes to form a continuous hinge also containing the fastener hinge knuckles of the second fastener; each of the third and fourth sidewall ends comprise a number of holes at a position and spacing such as that each hole on the third sidewall end matches a corresponding hole on the fourth sidewall end, and vice-versa, to form matched further hole pairs, each further hole pair in turn matching a corresponding tenon on the second fastener, and vice-versa; and both holes of each further hole pair being fastened to the respective tenon of the second fastener, to thereby also form an end-joined second sidewall.
